(19) United States
(12) Patent Application Publication
(10) Pub. No.: US 2025/0034403 A1
(43) Pub. Date: Jan. 30, 2025

(54) UV-CURABLE PRECURSOR SOLUTIONS FOR DEPOSITION OF MIXED METAL OXIDE FILMS CONTAINING TITANIUM, AND OPTICAL ELEMENTS FORMED BY LIQUID PHASE DEPOSITION OF METAL OXIDE FILMS

(71) Applicant: Phosio Corporation, Corvallis, OR (US)

(72) Inventors: Omid Sadeghi, Corvallis, OR (US); Douglas A. Keszler, Corvallis, OR (US)

(21) Appl. No.: 18/783,162

(22) Filed: Jul. 24, 2024

Related U.S. Application Data
(60) Provisional application No. 63/515,322, filed on Jul. 24, 2023.
(60) Provisional application No. 63/517,078, filed on Aug. 1, 2023.

(51) Int. Cl. C09D 1/00; C01G 23/053; C23C 22/64; C23C 22/82

(52) U.S. Cl. CPC C09D 1/00; C01G 23/053; C23C 22/64; C23C 22/82

(57) ABSTRACT

Examples are disclosed that relate to the use of acid-stabilized precursor solutions for forming low-cracking and crack-free titanium-containing oxide films by liquid phase deposition. One example provides a method for forming a titanium-containing oxide film by liquid-phase deposition. The method comprises film a substrate with an acid-stabilized aqueous precursor solution to form a film. The acid-stabilized aqueous precursor solution comprises titanium ions, one or more other metal ions, a photolyzable and/or pyrolyzable ligand, and an acid. The method further comprises exposing the film to one or more of heat or light. Examples are also disclosed that relate to forming optical devices using liquid phase deposition of metal oxide films.

### CROSS-REFERENCE TO RELATED APPLICATIONS

This application claims priority to U.S. Provisional Patent Application Ser. No. 63/515,322, filed Jul. 24, 2023 and titled UV-CURABLE PRECURSOR SOLUTION FOR DEPOSITION OF OXIDE COATINGS CONTAINING TITANIUM, LANTHANUM, AND TELLURIUM, and to U.S. Provisional Patent Application Serial No. and 63/517,078, filed Aug. 1, 2023 and titled VOLUME HOLOGRAPHIC GRATINGS BY LIQUID PHASE DEPOSITION OF METAL OXIDE FILM. The entire discloses of both of these provisional patent applications are hereby incorporated by reference in their entireties.

### BACKGROUND

Titanium oxide is commonly used as an optical material, such as an optical material in a diffractive optical element. This use is due at least in part to the relatively high refractive index of TiO₂ and low optical absorption coefficient of TiO₂ across the visible spectrum.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to acid-stabilized precursor solutions for forming low-cracking and crack-free titanium-containing oxide films. One example provides a method for forming a titanium-containing oxide film by liquid-phase deposition. The method comprises coating a substrate with an acid-stabilized aqueous precursor solution to form a film. The acid-stabilized aqueous precursor solution comprises titanium ions and one or more other metal ions, a photolyzable and/or pyrolyzable ligand, and an acid. The method further comprises exposing the film to one or more of heat or light.

Examples are also disclosed that relate to optical elements formed by liquid phase deposition of metal oxide films. One example provides a method of forming a metal oxide film, the method comprising coating a substrate with an acid-stabilized precursor solution to form a film, the acid-stabilized precursor solution comprising metal ions, a photolyzable and/or pyrolyzable ligand, and an acid. The method further comprises UV-curing first regions of the film and not UV-curing second regions of the film, and heating the film.

### BRIEF DESCRIPTION OF THE FIGURES

FIG. 1 shows a flow diagram of an example method for forming a titanium-containing oxide film using an acid-stabilized precursor solution.

FIG. 2 shows a sectional view of an example waveguide including an optical element comprising a titanium-containing oxide film.

FIG. 3 shows a top view of an example titanium oxide film formed on a waveguide with a surface comprising a plurality of gaps, which exhibits cracks that form in the oxide film during curing.

FIG. 4 shows a top view of an example titanium/lanthanum/aluminum oxide film formed on a waveguide with a surface comprising gaps, which exhibits relatively less cracking than the example of FIG. 3.

FIG. 5 shows a top view of an example titanium/lanthanum/tellurium oxide film formed on a waveguide with a surface comprising gaps, which exhibits no cracking.

FIG. 6 shows a flow diagram of an example method for forming a holographic grating by liquid phase deposition of an acid-stabilized precursor solution to form an inorganic film.

FIGS. 7A-7D schematically show example structures that can be formed using the method of FIG. 6.

FIGS. 8-11 shows graphs of refractive indices for UV-cured portions of example films and non-UV-cured portions of the films on different substrates.

FIG. 12 shows an example plot demonstrating the absorption of a film with increasing concentration of Te.

### DETAILED DESCRIPTION

Liquid phase deposition processes can be used to form metal oxide films. Such films can be used as coatings on optical elements. For example, features can be formed on a substrate. A spin-on deposition process can be performed to form a film on the substrate surface, thereby filling the features with a precursor solution. The film is then cured. Examples curing methods include UV curing, thermal curing, laser curing, and particle beam curing. The curing process helps remove solvent and volatile species from the film and form a metal ion-oxygen network.

However, the film can shrink during curing as solvent and volatile species are driven out of the film. This can lead to cracking in some examples. For example, where a titanium oxide film is formed on a waveguide surface comprising raised areas and gaps between the raised areas, the titanium oxide film can crack as it cures and shrinks. In some examples, metal oxide nanoparticles (e.g., TiO₂ nanoparticles) can be added to the precursor solution to help reduce shrinking during the curing process. However, even some titanium nanoparticle-containing oxide films may cracks as the film is cured.

Accordingly, examples are disclosed that relate to the use of acid-stabilized metal oxide precursor solutions for forming low-cracking and crack-free titanium-containing oxide films by liquid phase deposition. Briefly, in a liquid-phase deposition process, a substrate is coated with an acid-stabilized precursor solution to form a film. In some examples, the acid-stabilized precursor solution comprises titanium ions and one or more other metal ions. Examples of other metal ions include The acid-stabilized precursor solution further comprises a photolyzable and/or pyrolyzable ligand, and an acid. In some examples, the acid-stabilized precursor solution further comprises a component to slow solvent evaporation, such as a polyol (an alcohol with two or more hydroxyl groups (e.g. a diol)). The precursor solution may be shelf-stable for a relatively long duration (e.g. weeks, months, or even years in various examples). After coating the substrate, the film is exposed to one or more of light or heat. This cures the film to form an oxide film.

Due to the presence of the one or more additional metal ions in the precursor solution other than titanium, the oxide film can be more amorphous (i.e., glassy) than titanium oxide films. In other words, the presence of the different metal species may help to inhibit crystallization of the oxide film compared to a TiO₂ film cured under similar conditions. This can help to result in less cracking during the curing process than examples that omit such metal species. In some examples, an oxide film can be formed that is substantially free of cracks. In some such examples, a crack-free titanium-containing oxide film can be produced by liquid phase deposition using an acid-stabilized precursor solution comprising titanium ions, lanthanum ions, and one or more of tellurium ions, bismuth ions, tin ions, or antimony ions. As cracks can scatter light, a substantially crack-free oxide film can provide better optical performance than an oxide film that has a relatively greater concentration of cracks. As such, use of an acid-stabilized precursor solution according to the examples described herein can help form films for optical elements with better performance than optical elements formed using other precursor solutions.

The use of an acid-stabilized precursor solution according to the disclosed examples also can allow for the formation of a relatively thicker film than a titanium oxide film while avoiding cracking. Relatively thicker metal oxide films may be desired for certain applications compared to relatively thinner films. For example, when used as a diffractive optical element, a relatively thicker film (e.g. a film with a thickness of 100-1000 nm) can provide for increased light interaction within the grating compared to gratings formed in relatively thinner films. Another example is that holographic components need thicker films compared to other types of components.

Titanium-containing oxide films as disclosed herein can be used in any suitable device. As one example, an oxide film can be used on a waveguide. As another example, an oxide film can be used as a light extraction layer in an organic light-emitting diode (OLED) display panel. Further examples include use as optical claddings, and in optical components such as dichroic beam splitters, light diffuser, anti-reflective layers, cold mirrors, and hot mirrors. Example optical devices are described in more detail below.

Titanium-containing oxide films as disclosed herein also can be used in thin-film transistors (TFTs). Some TFTs include a dielectric to insulate a gate from an active layer. For example, an indium-gallium-zinc-oxide (IGZO) TFT can comprise a SiO₂ dielectric layer between a gate and an active IGZO layer. The dielectric layer can be formed in a patterning process or gapfill process, as examples. Atomic layer deposition (ALD) is typically used to perform dielectric gapfill. However, voids and seams can develop during ALD gapfill, which can lead to device failure. Additionally, it is beneficial for the films to exhibit atomic-scale smoothness and be deposited at comparatively low temperatures to avoid or reduce SiGe out-diffusion. Performing void-free ALD gapfill at low temperatures can be challenging and expensive compared to other deposition techniques.

Accordingly, the disclosed titanium-containing oxide films can be used in a liquid phase deposition process to form a void-free passivation layer and/or dielectric layer in a TFT at low temperatures (as low as 150° C.). In some such examples, a substrate is coated with an acid-stabilized precursor solution comprising titanium ions and one or more other metal ions to form a film. The film is cured to form a dielectric layer of a TFT, the dielectric layer comprising an oxide film comprising titanium and one or more other metal ions. Examples of other metal ions include lanthanum, tellurium ions, tin ions, bismuth ions, and antimony ions. Other examples are listed below. In some examples, a pattern is imprinted onto the film before the film is cured. In some examples, the liquid phase deposition process comprises forming the film within gaps on the substrate. As described above, the different metal oxides in the film can reduce a level of crystallinity of the oxide film compared to a TiO₂ film cured under similar conditions. The reduced crystallinity can result in less cracking during the curing process than examples that omit such metal species. This helps form a dielectric layer that is void-free and crack-free. As such, the examples disclosed herein can provide a liquid-phase deposition method for forming a dielectric layer of a TFT that is less complex, faster, and less expensive than other methods, such as ALD gapfill.

The example acid-stabilized precursor solutions can comprise titanium and any other suitable metal ions at any suitable concentrations. In some examples, an acid-stabilized precursor solution comprises titanium ions and one or more of Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Te, Sb, Yb, or Lu ions. Metal ions can be introduced into the acid-stabilized precursor solution in any suitable manner. In some examples, the metal ions are introduced into the acid-stabilized precursor solution in the form of a metal chloride. As one illustrative example, solid lanthanum chloride (LaCl₃) and solid tellurium chloride (TeCl₄) can be added to aqueous titanium chloride (TiCl₃) in 3% hydrochloric acid. In other examples, any other suitable compounds can be used, such as metal sulfates or metal nitrates.

The example acid-stabilized precursor solutions can comprise any suitable photolyzable and/or pyrolyzable ligand. In some examples, the acid-stabilized precursor solution comprises hydrogen peroxide (H₂O₂). Additionally or alternatively, formic acid (CH₂O₂) can be used. Additionally or alternatively, nitrate ions (NO₃⁻) can be used. The example acid-stabilized precursor solutions may omit organic species such as alkoxo ligands, and thereby may be deposited, dried, and cured at lower temperatures than precursor solutions comprising organic species. Additionally, use of a UV-curable ligand can be used, such as a peroxide, formic acid, or nitrate ion, can help provide a precursor solution that is curable upon exposure to UV light.

The example acid-stabilized precursor solutions can comprise any suitable acid. Examples include hydrochloric acid (HCl), nitric acid (HNO₃), and sulfuric acid (H₂SO₄). The use of an acid in the precursor solution helps avoid precipitation of metal species. As such, the example acid-stabilized precursor solutions described herein can comprise relatively long shelf lives, based upon times for observed precipitate formation.

An acid-stabilized precursor according to the disclosed examples also can include other components to address various issues encountered in some applications. For example, during the drying process for thick films, solvent may evaporate before the film components can rearrange to a stable conformation. This can cause cracks. Thus, one or more components can be added to help slow the evaporation of the solvent during curing. Example components to slow the evaporation of solvent during curing include polyhydric alcohols (polyols), such as diols. In an experiment, the addition of ethylene glycol to an acid-stabilized precursor solution resulted in a >400 nm thick film substantially free of cracks.

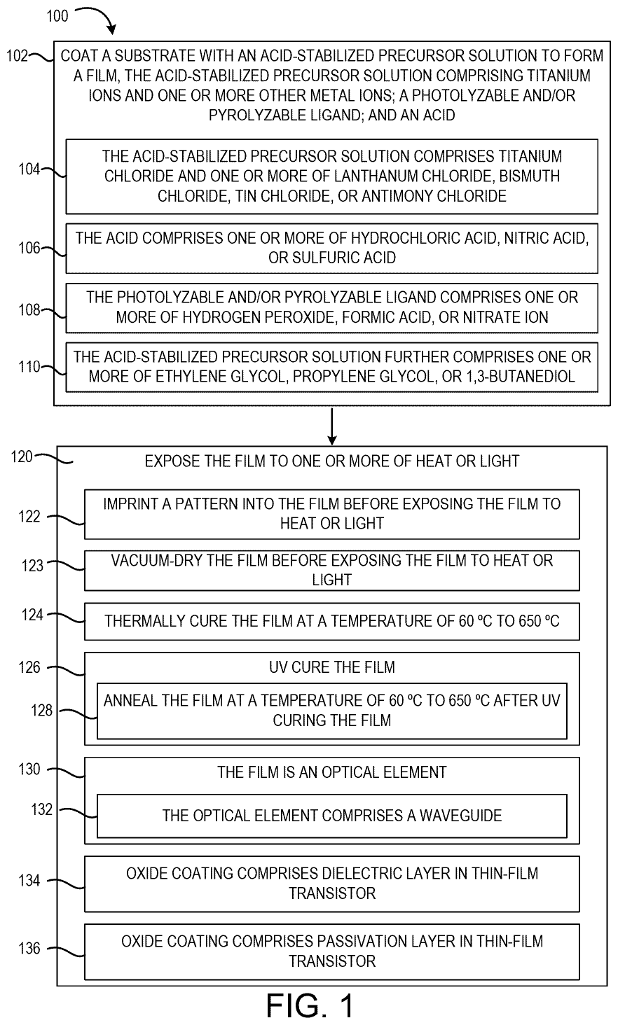

FIG. 1 shows a flow diagram of an example method 100 for forming a titanium-containing oxide film by liquid phase deposition. Method 100 comprises, at 102, film a substrate with an acid-stabilized precursor solution to form a film. The acid-stabilized precursor solution comprises titanium ions and one or more other metal ions. The acid-stabilized precursor solution further comprises a photolyzable and/or pyrolyzable ligand and an acid. Example metal ions that can be used in addition to Ti include Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Te, Sb, Yb, or Lu ions.

In some examples, at 104, the acid-stabilized precursor solution comprises titanium chloride, and one or more of lanthanum chloride, bismuth chloride, tin chloride, aluminum chloride, or antimony chloride. Alternatively or additionally, in some examples, one or more nitrates (e.g., titanium nitrate, lanthanum nitrate, aluminum nitrate, tellurium nitrate), nanoclusters (e.g. Al₁₃(OH)₂₄(H₂O)₂₄(NO₃)₁₅) and/or sulfates (e.g., titanium sulfate, lanthanum sulfate, tellurium sulfate) can be used. In some examples, at 106, the acid comprises one or more of hydrochloric acid, nitric acid, or sulfuric acid. Further, in some examples, at 108, the photolyzable and/or pyrolyzable ligand comprises one or more of hydrogen peroxide, formic acid, or nitrate ion. In some examples, at 110, the acid-stabilized precursor solution further comprises a polyol. For example, in some examples, the acid-stabilized precursor solution can comprise one or more of ethylene glycol, propylene glycol, or 1,3-butanediol. In other examples, any other suitable polyol may be used. In some examples, the acid-stabilized precursor solution can further comprise metal oxide nanoparticles, such as TiO₂ nanoparticles. Continuing, method 100 further comprises, at 120, exposing the film to one or more of heat or light. This cures the film to form an oxide film comprising titanium and one or more other metal ions. Examples include aluminum, lanthanum, tellurium, bismuth, tin, and/or antimony. In some examples, at 122, method 100 further comprises imprinting a pattern into the film before exposing the film to heat or light. In some examples, at 123, method 100 further comprises vacuum-drying the film before exposing the film to heat or light. In some examples, at 124, exposing the film to heat comprises thermally curing the film at a temperature of 60° C. to 650° C. Unless stated otherwise, numerical ranges are inclusive of the endpoints, i.e., “X to Y” includes the values X and Y. In some examples, a film cured at a relatively higher temperature (e.g., >300° C.) can comprise a higher optical absorption coefficient in the blue range of the visible spectrum than a film cured at a relatively lower temperature (e.g., <300° C.). In some examples, at 126, exposing the film to light comprises UV curing the film. In some such examples, a UV-curable ligand can be used, such as hydrogen peroxide, formic acid, and/or nitrate ions. In some such examples, nitric acid can be used, which can help with UV curing. In some examples, exposing the film to light comprises exposing the film to a laser. In some examples, at 128, method 100 further comprises annealing the film after UV-curing the film. Annealing can be performed at any suitable temperature, such as a temperature of 60° C. to 650° C.

In some examples, at 130, the film is formed on an optical element. In some such examples, at 132, the optical element comprises a waveguide. For example, method 100 can comprise forming a diffractive grating on a waveguide. In some examples, the waveguide can be incorporated into a near-eye device. In some examples, the film is deposited onto a substrate as part of a TFT fabrication process. In some examples, at 134, the oxide film comprises a dielectric layer in a TFT. In some examples, at 136, the oxide film comprises a passivation layer in a TFT.

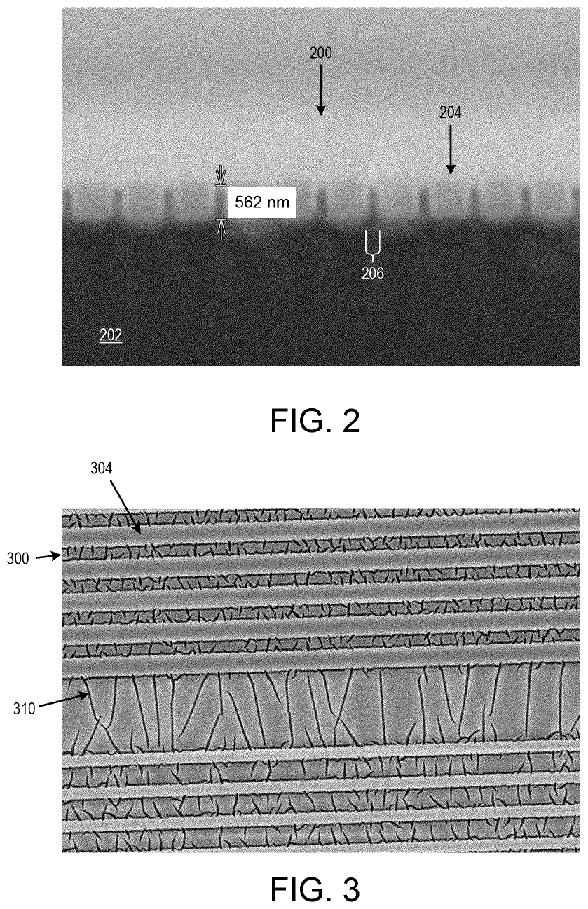

FIG. 2 shows a sectional view of an example optical element 200 comprising an oxide film. Optical element 200 can be formed using method 100, for example. The optical element 200 is formed on the surface of a substrate 202 comprising features 204. As shown in FIG. 2, features 204 are approximately 562 nm tall. In this example, spin-on deposition is used to deposit a film onto substrate 202 to fill gaps 206 between features 204. The film can be cured to form optical element 200 by exposing the film to heat or light, for example.

FIG. 3 shows a top view of an example oxide film 300 comprising titanium atoms. Oxide film 300 is formed between features 304 on a substrate. The oxide film 300 is formed using a precursor solution that omits other metal ions. As a result, oxide film 300 shrinks and cracks during curing. This forms cracks 310 in the oxide film 300. Cracks 310 can cause light scattering and device failure.

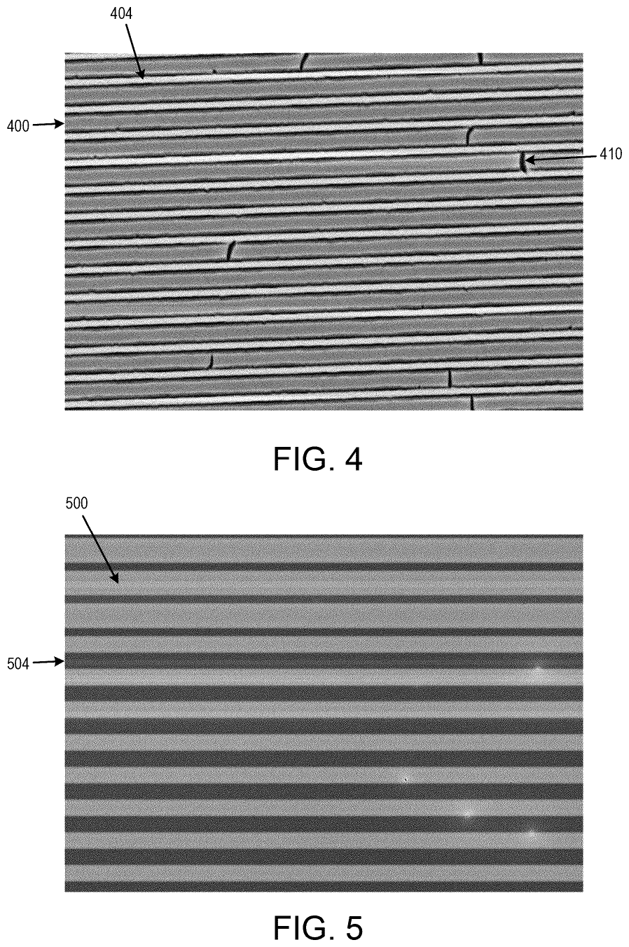

FIG. 4 shows a top view of another example oxide film 400 comprising titanium, lanthanum, and aluminum. For example, oxide film 400 may comprise a mixture of titanium oxide, lanthanum oxide, and aluminum oxide, and may be at least partially amorphous. Oxide film 400 is formed between features 404 on a substrate. The oxide film 400 comprises cracks 410. The oxide film 400 is formed using a precursor solution that includes titanium ions, lanthanum ions, and aluminum ions. As a result, the titanium-containing oxide film 400 is more amorphous and exhibits relatively less cracking than the example of FIG. 3. Thus, inclusion of lanthanum ions and aluminum ions in an acid-stabilized precursor solution can help reduce cracking in liquid phase deposition of titanium-containing oxide films.

FIG. 5 shows a top view of another example oxide film 500 comprising titanium, lanthanum, and tellurium. For example, oxide film 500 may comprise a mixture of titanium oxide, lanthanum oxide, and tellurium oxide, and may be at least partially amorphous. The film 500 was formed by spin-deposition of a precursor solution comprising 3 mL TiCl₃·3HCl (30%) (aq)+1 g TeCl₄(s)+1 g LaCl₃(s)+1 mL H₂O₂(aq) (30%). The film was thermally cured at a temperature of 200° C. Oxide film 500 (lighter portions) is formed between features 504 (darker portions) on a substrate. The oxide film 500 is formed using a precursor solution according to examples described herein that includes titanium ions, lanthanum ions, tellurium ions, a photolyzable and/or pyrolyzable ligand, and an acid. As a result, the oxide film 500 does not crack upon curing. This is because the inclusion of lanthanum and tellurium in a titanium-containing oxide film helps form an oxide film that is more amorphous and less prone to cracking than oxide films that omit such metal ions. As mentioned above, an acid-stabilized precursor solution according to the disclosed examples can be used to form diffractive optical elements. Diffractive optical elements can be used to direct light in optical systems. Examples of diffractive optical elements include diffractive relief gratings and volume holographic gratings. These can be incorporated into a waveguide combiner, for example, to combine real-world imagery with displayed imagery. Such waveguide combiners can be used in virtual reality and augmented reality systems.

Volumetric holographic gratings are typically formed using an organic photopolymer. A volumetric holographic grating can be made by superimposing wavefronts to create an interference pattern which is recorded in a holographic medium. Laser light can be used to create a fringe pattern in the holographic medium to form a volume holographic grating. Such gratings can be used in a diffractive waveguide, for example.

However, organic films can degrade over time. For example, UV radiation and oxidation can cause organic films to absorb blue light and give the film a yellowish hue. Organic films also can become brittle over time. Further, organic polymers can have a relatively low refractive index dynamic range, e.g., Δn≤0.04. The dynamic range An refers to the difference of refractive index values for different of a material. A lower dynamic range results in relatively less diffraction efficiency (less diffracted light). Organic films also can have relatively high haze (i.e., light scattering), which can be 0.2% or more in some examples. Ultimately, the organic films can suffer from a self-interchange issue, triggered by heat, leading to degradation in the dynamic range.

Accordingly, examples are disclosed that relate to the use of metal oxide films as holographic media and forming diffractive optical elements by liquid phase deposition of metal oxide films. A metal oxide film that is UV-cured and heated comprises a different refractive index than a metal oxide film that is heated without UV-curing due to difference in the film densities. UV exposure removes organics from such areas, increasing density in the exposed areas. After heating, the UV-exposed portions of the film will be denser and have a higher refractive index than in the unexposed areas. In the unexposed areas, organics are burned off simultaneously during hard baking. As a result, the film does not become as dense and has lower refractive index.

As such, UV light can be used to record holographic data and/or form a holographic optical element in a metal oxide film, which is then heated to set the film. Briefly, liquid phase deposition is used to deposit an inorganic precursor solution to form a film on a substrate. The precursor solution comprises metal ions, an acid, and a photolyzable and/or pyrolyzable ligand, such as described above. A hologram is recorded in the film by UV laser curing. Due to the interference pattern, the UV laser light cures and increases the density in first regions of the film and does not cure other, second regions of the film. Then, the film is baked. Baking the film changes the refractive index of the first regions and second regions. Due to UV curing increasing the density of the first regions, the refractive index is different than the refractive index of the annealed second regions. As such, the method can be used to record a hologram. In some examples, holographic data can be recorded into a metal oxide film. In some examples, a UV laser interference pattern can be recorded into a metal oxide film to form a volume holographic grating. This can be used to form a diffractive grating on a waveguide, for example.

The disclosed example metal oxide films can have higher dynamic range, greater durability, and lower haze than organic films. Further, metal oxide films are not prone to yellowing as some organic films. The holographic medium can comprise any suitable metal oxide, including a metal oxide deposited using an acid-stabilized precursor solution according to the examples disclosed herein. As described below, in some examples, a refractive index dynamic range of 0.10 or greater can be achieved for UV-cured and non-UV-cured portions of a metal oxide film. Additionally, vacuum-drying films prior to UV curing may increase the dynamic range. Further, the refractive indices can be relatively large (e.g., 1.7<n<2.5) compared to the refractive index of organic films. For example, Group IV oxides (such as TiO₂, ZrO₂, and HfO₂) can provide such refractive indices, as well as low optical absorption coefficient, across the visible spectrum. A volume holographic grating comprising a metal oxide film formed according to the disclosed examples can have higher diffraction efficiency than organic films. This can provide better performance with thinner films in waveguide systems than organic films.

A variety of precursor solutions can be formed and used in liquid-phase deposition of metal oxide films as disclosed. In some examples, an aqueous acid-stabilized precursor solution according to the present disclosures can comprises one or more group 4 or 13 ions and one or more other ions from group 1 and/or group 2 and/or group 3, and/or group 4, and/or group 5, and/or group 13 and/or group 14 and/or group 15 and/or F-block ions, referring to groups in the periodic table of the elements. Some illustrative examples include TiO₂, AlₓTi_{y}Oₙ, Al_{w}TiₓLa_{y}Bi_{z}OₙTeₓTi_{y}Oₙ, NbₓTi_{y}Oₙ, TiO₂/TiO₂ nanoparticle composites, other metal oxide/metal oxide nanoparticle composites, ZrO₂, ZrₓTi_{y}Oₙ, CeₓTi_{y}Oₙ, LaₓTi_{y}Oₙ, LiₓLa_{y}Ti_{z}O_{nz}, LiₓBi_{y}Ti_{z}Oₙ, Nb_{w}LaₓLi_{y}Ti_{z}Oₙ, and AlᵥNb_{w}LaₓLi_{y}Ti_{z}Oₙ. Further examples include metal oxides comprising Ti, La, and one or more of Te, Bi, or Sb, such as LaₓTe_{y}Ti_{z}Oₙ, LaₓBi_{y}Ti_{z}Oₙ, and LaₓSb_{y}Ti_{z}Oₙ.

Metal oxide films prepared using the disclosed example acid stabilized precursor solutions can be used for a potentially wide variety of applications. Examples include optical films, energy storage, semiconductor devices, Photonic Integrated Circuits (PICs), and biomedical devices. As a more specific example, TiO₂ and mixed metal oxide/TiO₂ acid-stabilized precursor solutions according to the disclosed examples can be used to deposit titanium oxide films with high-thermal stability (>800° C.), high-optical transparency (>90% @ 550 nm), and tunable refractive indices (1.7<n<2.5). Compositions and post-deposition processing can be controlled to modulate refractive index and optical transparency.

The disclosed example precursor solutions may be deposited on substrates by any suitable method. Examples include spin coating, dip coating, doctor blading, spray coating, electrodeposition, and printing methods (e.g. jet printing, screen printing, etc.). The disclosed example precursor solutions can be formed from various different metal-containing compounds. For example, a precursor solution for forming a TiO₂ film can be formed from titanium-containing species such as TiO₂, TiCl₃·xHCl (x=0-200), and/or TiCl₄(l). A precursor solution according to the present disclosure can be aqueous, and/or can include another suitable solvent.

An acid-stabilized precursor solution for forming a holographic recording medium (e.g. for fabricating a diffractive optical element) can comprise any suitable metal ions at any suitable concentrations. In some examples, the metal ions comprise ions of one or more of Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Te, Sb, Yb, or Lu. In some examples, the acid-stabilized precursor solution comprises one or more group 4 or 13 ions and one or more other ions from group 1 and/or group 2 and/or group 3, and/or group 4, and/or group 5, and/or group 13 and/or group 14 and/or group 15 and/or F-block ions. In some examples, the acid-stabilized precursor solution comprises Ti and Te. In some examples, the acid-stabilized precursor solution comprises Ti, La, and one or more of Te, Bi, or Sb ions. In some examples, the acid-stabilized precursor solution comprises Ti, La, and Al. In some examples, the acid-stabilized precursor solution comprises Te, Bi, or Sn ions. Some illustrative examples include TiO₂, AlₓTi_{y}Oₙ, TeₓTi_{y}Oₙ, NbₓTi_{y}Oₙ, TiO₂/TiO₂ nanoparticle composites, other metal oxide/metal oxide nanoparticle composites, ZrO₂, ZrₓTi_{y}Oₙ, CeₓTi_{y}Oₙ, LaₓTi_{y}Oₙ, LiₓLa_{y}Ti_{z}O_{nz}, LiₓBi_{y}Ti_{z}Oₙ, Nb_{w}LaₓLi_{y}Ti_{z}Oₙ, and AlᵥNb_{w}LaₓLi_{y}Ti_{z}Oₙ. Further examples include metal oxides comprising Ti, La, and one or more of Sn, Te, Bi, or Sb, such as LaₓTe_{y}Ti_{z}Oₙ, LaₓBi_{y}Ti_{z}Oₙ, and LaₓSb_{y}Ti_{z}Oₙ.

Metal ions can be introduced into the acid-stabilized precursor solution in any suitable form. In some examples, the metal ions are introduced into the acid-stabilized precursor solution as a metal chloride. As one illustrative example, solid lanthanum chloride (LaCl₃) and solid tellurium chloride (TeCl₄) can be added to aqueous titanium chloride (TiCl₃) in 3% hydrochloric acid. In other examples, any other suitable compounds can be used, such as metal sulfates or metal nitrates.

As mentioned above, an acid-stabilized precursor solution can comprise a photolyzable and/or pyrolyzable ligand. The term “photolyzable and/or pyrolyzable ligands” represents ligands that that decompose or otherwise leave a film formed by the precursor solution when exposed to light (e.g. UV light) and/or sufficient heat (e.g., temperatures of 60° C. to 650° C.). Photolyzable and/or pyrolyzable ligands can include oxygen-containing ligands that contribute to the formation of a metal ion-oxygen network. Examples of photolyzable and/or pyrolyzable ligands include hydrogen peroxide, formic acid, and nitrate ions.

To enable curing using UV laser light, a precursor solution according to the present disclosure can include a UV-curable ligand. As one example, hydrogen peroxide can be used as a UV-curable ligand. In other examples, other suitable UV-curable ligands may be used. Examples include other peroxides (e.g. lithium peroxide, sodium peroxide, etc.), formic acid or other carboxylic acids, and nitrate ions. Use of a UV-curable ligand allows changing the density of the film and allows a hologram to be encoded into the metal oxide film using UV laser light. Further, the example acid-stabilized precursor solutions may omit organic species such as alkoxo ligands, and thereby may be deposited, dried, and cured at lower temperatures than precursor solutions comprising organic species. In some examples, a precursor solution can comprise one or more ligands in addition to a UV-curable ligand.

Further, in some examples, an organic peroxide or acid may be used as a photolyzable and/or pyrolyzable ligand. However, organic peroxides may require the use of additional safety measures due to the potential low stability and combustibility of organic peroxides. Formic acid and hydrogen peroxide offer the additional advantage that no carbon from organic species needs to be removed by a relatively high-temperature post-deposition heating step, as the carbon in formic acid converts to CO₂ gas upon curing of the deposited film. As illustrative examples, a titanium-containing precursor solution can include, as examples, TiX₃ (x=Cl⁻, Br⁻, I⁻, NO₃⁻, OOCH⁻, etc.)+H₂O₂, TiX₄ (x=Cl⁻, Br⁻, I⁻, NO₃⁻, OOCH⁻, etc.)+H₂O₂, or TiOSO₄+H₂O₂ as metal source/ligand combinations. In some examples, a precursor solution can include metal nitrates (e.g., titanium nitrate) or metal sulfates (e.g., titanium sulfate).

The example acid-stabilized precursor solutions can comprise any suitable acid. Examples include hydrochloric acid (HCl), nitric acid (HNO₃), and sulfuric acid (H₂SO₄). The use of an acid in the precursor solution helps avoid precipitation of metal species. As such, the example acid-stabilized precursor solutions described herein can comprise relatively long shelf lives, based upon times for observed precipitate formation.

As mentioned above, in some examples, an acid-stabilized precursor solution can include a component to help reduce a rate of solvent evaporation from a film formed using the acid-stabilized precursor solution. In some examples, a polyol, such as a diol, can be used to reduce a rate of solvent evaporation from a film of the acid-stabilized precursor solution. Example polyols include ethylene glycol ((CH₂OH)₂), propylene glycol (CH3CH(OH)CH₂OH), 1,3-butanediol and 1,4-butanediol.

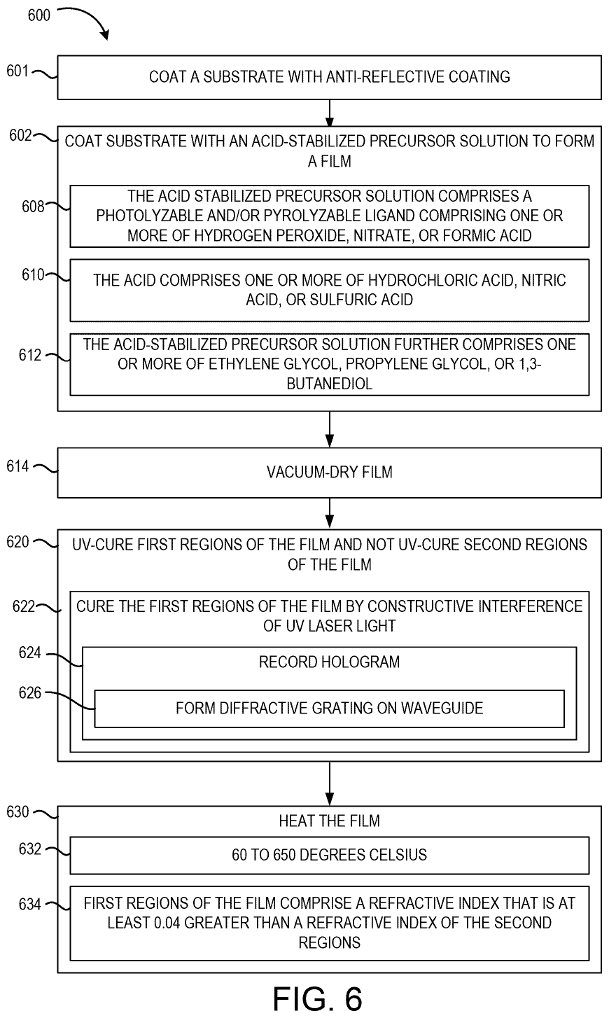

FIG. 6 shows an example method 600 for forming a volume holographic grating. At 601, method 600 optionally comprises coating a substrate with an anti-reflective film. When a pattern is recorded in a holographic medium, the substrate surface may reflect light back through the optically transparent film during curing, causing unwanted curing of portions of the film. This can result in pattern blurring and ghosting. Thus, an anti-reflective film can be applied to the surface of the substrate prior to deposition and patterning of the holographic medium to mitigate pattern blurring. The anti-reflective film may, for example, comprise a multilayer dielectric film tuned to wavelength of light used to record the hologram.

At 602, method 600 comprises coating the substrate with an acid-stabilized precursor solution to form a film. The acid-stabilized precursor solution comprises metal ions, a photolyzable and/or pyrolyzable ligand, an acid, and optionally a polyol. In some examples, the metal ions comprise ions of one or more of Al, Ga, Bi, Sc, Cu, Al, Sc, V, Cr, Mn, Fe, Co, Ni, Zn, Y, Zr, Nb, Mo, In, Sn, Sb, Hf, Ta, W, Ir, Pt, La, Ce, Pr, Nd, Pm, Sm, Eu, Gd, Tb, Dy, Ho, Er, Tm, Te, Sb, Yb, or Lu. In some examples, the acid-stabilized precursor solution comprises one or more group 4 or 13 ions and one or more other ions from group 1 and/or group 2 and/or group 3, and/or group 4, and/or group 5, and/or group 13 and/or group 14 and/or group 15 and/or F-block ions.

In some examples, at 608, the photolyzable and/or pyrolyzable ligand comprises one or more of hydrogen peroxide, nitrate ions, or formic acid. In other examples, any other suitable photolyzable and/or pyrolyzable ligand can be used. In some examples, at 610, the acid comprises one or more of hydrochloric acid, nitric acid, or sulfuric acid. In other examples, any other suitable acid can be used. In some examples, at 612, the acid-stabilized precursor optionally further comprises one or more polyols, such as one or more of ethylene glycol, propylene glycol, or 1,3-butanediol. In other examples, any other suitable polyol may be used. The method 600 optionally may comprise, at 614, vacuum-drying the film before proceeding to UV curing, as described below.

Continuing, at 620, method 600 further comprises UV-curing first regions of the film and not UV-curing second regions of the film. This increases the density of the first regions of the film. In some examples, at 622, method 600 comprises curing the first regions of the film by constructive interference of UV laser light. In other examples, a mask can be used. In some such examples, at 624, method 600 comprises recording a hologram into the film. In such some examples, at 626, method 100 comprises forming a diffractive grating on a waveguide. The diffractive grating can have any suitable orientation. In some examples, the diffractive grating can be oriented vertically with respect to a plane of the substrate. In other examples, the diffractive grating can be oriented at another angle (e.g. slanted) with respect to the plane of the substrate. Continuing, at 630, method 100 comprises heating the film. In some examples, at 632, heating the film comprises heating the film to a temperature of 60° C. to 650° C. Heating the film changes the refractive indices of the first regions and second regions of the film and stabilizes the film (sets the film). In this manner, the refractive index of the film does not change further after heating. Heating the film can drive solvent (e.g., water) out of the film. This can cause the film to shrink. In some examples, the first regions exhibit greater shrinkage than the second regions upon heating. As discussed above, due to the UV-curing of the first regions and increasing the density of the film, the refractive index of the first regions n₁ is greater than the refractive index of the second regions n₂. Here, the dynamic range of the film is Δn=n₁−n₂. In some examples, at 634, the first regions of the film comprise a refractive index that is at least 0.01 greater than a refractive index of the second regions. In other words, Δn≥0.01. In some examples, an annealing temperature can be selected to help control the refractive index and/or dynamic range of the metal oxide film. For example, the refractive index can be tuned by electromagnetic radiation dose (e.g., UV, laser, IR, X-ray, Gamma, etc.). In some examples, the dynamic range can be tuned by electromagnetic radiation. Alternatively or additionally, in some examples, the film density can be tuned by electromagnetic radiation. In some examples, the refractive index of the first regions and the second regions can be tuned by the film composition, drying process, curing temperature, UV exposure time, and/or UV exposure power. In some examples, the dynamic range can be tuned by the film composition, drying process, curing temperature, UV exposure time, and/or UV exposure power.

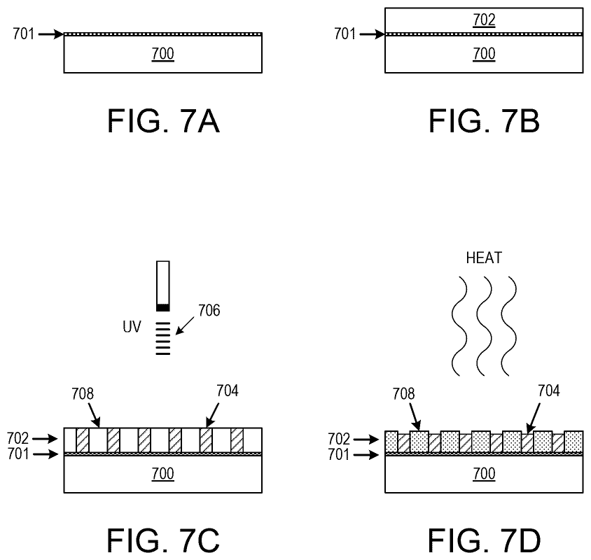

FIGS. 7A-7D show schematic sectional views of example structures that can be formed using method 600. FIG. 7A shows a substrate 700. Substrate 700 can comprise any suitable material onto which a volumetric holographic grating can be formed. In some examples, substrate 700 comprises a waveguide. FIG. 7B shows a film 702 deposited onto substrate 700, for example, by performing step 602 of method 600. Film 702 is deposited using an acid-stabilized precursor solution according to the examples disclosed herein. The precursor solution comprises metal ions, a photolyzable and/or pyrolyzable ligand, and an acid, and in some cases a polyol (e.g. a diol) or other component configured to slow a rate of solvent evaporation. In some examples, film 702 is vacuum-dried before curing (not shown in FIGS. 7A-7D).

FIG. 7C shows curing of first regions 704 by exposing the first regions to UV light 706, for example, by performing step 620 of method 600. As shown in FIG. 7C, second regions 708 are not exposed to UV light 706. In this example, two wavefronts from a UV laser create an interference pattern. First regions 704 represents regions of constructive interference. This provides for UV-curing of first regions 704. Second regions 708 represent regions of destructive interference. Thus, second regions 708 are not UV-cured. In other examples, a pattern may be created by a mask (not shown in FIG. 7).

FIG. 7D shows substrate 700 following a heating step, for example, by performing step 630 of method 600. The heating step stabilizes film 702 (sets the film). Due to the UV-curing and higher density, first regions 704 comprise a refractive index n₁ that is greater than a refractive index n₂ of second regions 708, which are heated but not UV-cured. FIG. 7D also schematically illustrates shrinkage of first regions 704 and second regions 708. As shown, first regions 704 shrink more than second regions 708. In some examples, first regions and second regions may shrink a similar amount.

In some examples, film 702 can serve as a holographic medium for recording holographic data. In some examples, film 702 can be used as a diffractive optical element, such as a volume holographic grating on a waveguide. While depicted as a vertically-oriented grating, in other examples, the grating elements can be oriented with a slant relative to substrate 700. In some examples, one or more additional layers can be deposited onto film 702. For example, method 600 can be repeated to deposit an additional volume holographic grating on top of film 702. In some examples, two or more volume holographic gratings can be stacked. In some such examples, each volume holographic grating is configured for diffracting a different wavelength of light from a display (e.g., red, green, blue).

In one experiment, six silicon wafer substrates were cut to a roughly 1-inch square. The substrates were then plasma treated for 10 minutes. A film was spin coated on in a vacuum chamber for 60 seconds at a maximum spin rate of 3000 rpm at an acceleration rate of 3000 rpm/s. The film was applied using a precursor solution according to the examples disclosed herein.

A mask was created by propping up an aluminum foil covered 2-inch square glass with sufficient height between the films and glass to avoid direct contact, heat transfer, and lessen reflected light reaching the substrate.

After spin coating, the substrates were UV cured with a 5 J/cm² dose. During this step, half of the film area of each substrate is UV cured. However, the other half of the film area is covered by a mask and is not UV cured and has a lower density. Following UV curing, the films were baked at 400° C. for 15 minutes in a furnace. In another experiment, the films were baked at 250° C. for 10 minutes.

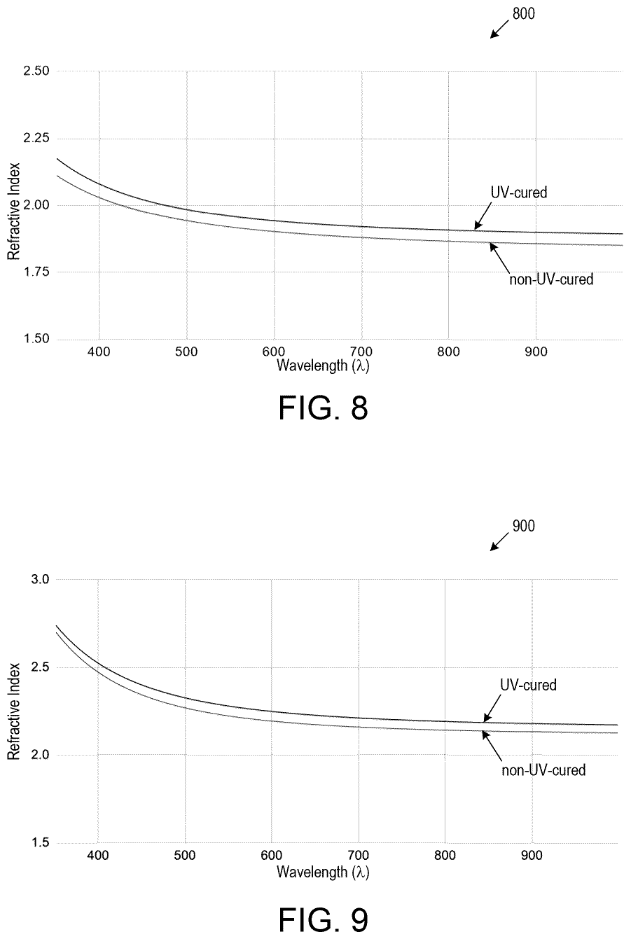

FIG. 8 shows a graph 800 of refractive index for the UV-cured portion of a film and non-UV-cured portion of the film for one substrate. The film is titanium aluminum oxide, with 75% titanium and 25% aluminum (molar percentages). Graph 800 shows a fit of refractive index measurements according to the Cauchy's equation

$$( n ( λ ) = A + \frac{B}{{λ}^{2}} + \frac{C}{{λ}^{4}} + … ) .$$

The film was UV cured with a 5 J/cm² dose and baked at 400° C. for 15 minutes. A mask was used such that half the film area was UV-cured and the other half was not UV-cured. According to the fits, n=1.957 for the UV-cured portion of the film and n=1.913 for the non-UV-cured portion of the film. Thus, the film exhibited a Δn of 0.044. Further, after baking, the UV-cured portion of the film measured 98 nm thickness and the non-UV-cured portion of the film measured 105 nm thickness.

FIG. 9 shows a graph 900 of Cauchy's equation fit of refractive indices for a titanium oxide film. The titanium oxide film was UV cured with a 5 J/cm² dose (using a mask to cover half the film area) and baked at 400° C. for 15 minutes. According to the fits, n=2.278 for the UV-cured portion of the film and n=2.221 for the non-UV-cured portion of the film. Thus, the second film exhibited a Δn of 0.057. Further, after baking, the UV-cured portion of the film measured 63 nm thickness and the non-UV-cured portion of the film measured 67 nm thickness.

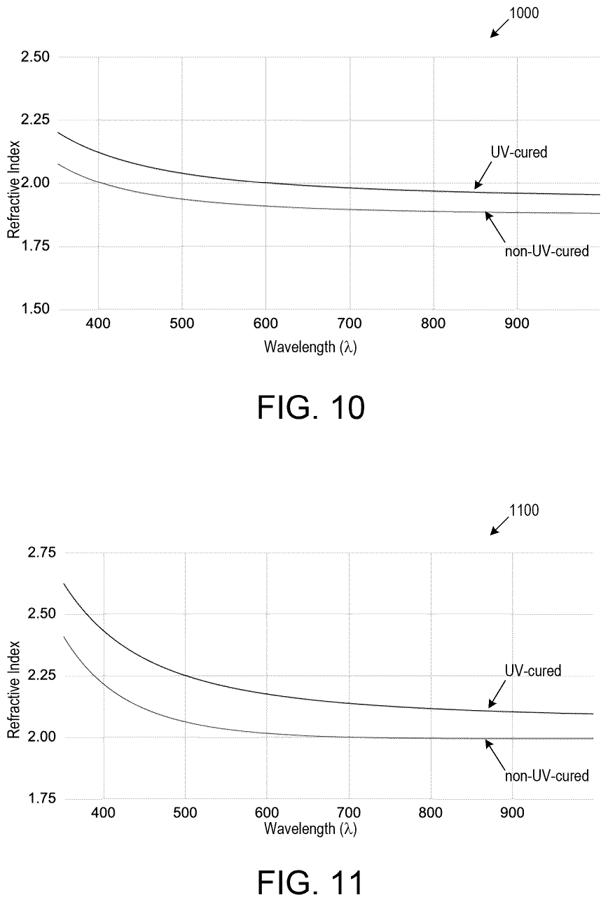

FIG. 10 shows a graph 1000 of Cauchy's equation fit of refractive indices for a third film. The third film was formed using a precursor solution comprising 33% Ti, 33% Te, and 33% La (molar percentages). The film was UV cured with a 5 J/cm² dose (using a mask to cover half the film area) and baked at 250° C. for 10 minutes. According to the fits, n=2.01 for the UV-cured portion of the film and n=1.91 for the non-UV-cured portion of the film. Thus, the third film exhibited a Δn of 0.10. Further, after baking, the UV-cured portion of the film measured 115 nm thickness and the non-UV-cured portion of the film measured 140 nm thickness.

FIG. 11 shows a graph 1100 of Cauchy's equation fit of refractive indices for a fourth film. The fourth film was formed using a precursor solution comprising 72% Ti and 28% Te (molar percentages). The film was UV cured with a 5 J/cm² dose (using a mask to cover half the film area) and baked at 250° C. for 10 minutes. According to the fits, n=2.20 for the UV-cured portion of the film and n=2.04 for the non-UV-cured portion of the film. Thus, the second film exhibited a Δn of 0.16. Further, after baking, the UV-cured portion of the film measured 95 nm thickness and the non-UV-cured portion of the film measured 119 nm thickness.

As discussed above, various metal oxides can be used as holographic films according to the present disclosure. Some examples include titanium dioxide (TiO₂), zirconium dioxide (ZrO₂), hafnium oxide (HfO₂), lithium titanium oxide, strontium titanium oxide, yttrium titanium oxide, titanium zirconium oxide, niobium titanium oxide aluminum titanium oxide, titanium tin oxide, bismuth titanium oxide, titanium lanthanum oxide, titanium lanthanum tellurium oxide, titanium lanthanum bismuth oxide, titanium lanthanum antimony oxide, titanium lanthanum aluminum oxide, cerium titanium oxide, lithium aluminum oxide, aluminum strontium oxide, yttrium aluminum oxide, niobate aluminate, tin aluminum oxide, bismuth aluminum oxide, aluminum lanthanum oxide, lithium lanthanum titanium oxide, and lithium bismuth titanium oxide.

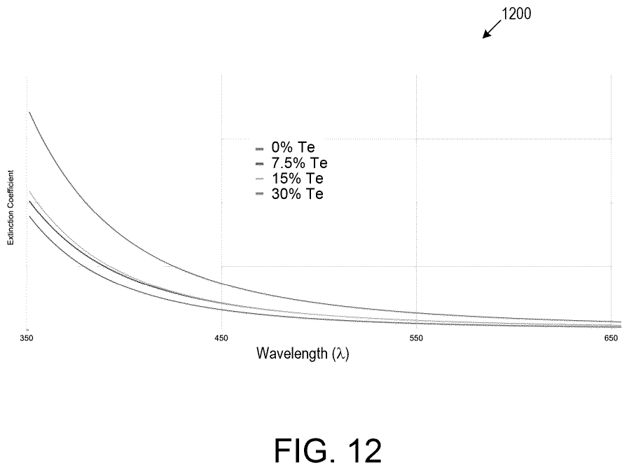

The efficiency of recording a hologram, such as a diffractive optical element, in a metal oxide film according to the present disclosure can be increased by increasing an amount of light absorbed by the metal oxide film during recording of the hologram to form the diffractive optical element. This can be achieved by adding metal ions which absorb more strongly at the wavelength used to record the hologram. Examples of metal ions that can be included in a metal oxide film to cause relatively high absorption compared to other ions include silver, bismuth indium, tin, antimony, and tellurium. FIG. 12 shows an example plot 1200 demonstrating the absorption of a tellurium-doped titanium dioxide (TiO₂) film with increasing concentration of Te. As the concentration of Te ions in the precursor solution increases from 0% to 7.5%, to 15% and to 30%, the absorption of 400 nm light increases.

Thus, the example acid-stabilized precursor solutions can help avoid cracking during liquid phase deposition of titanium-containing oxide films. In particular, acid-stabilized precursor solutions comprising titanium ions, lanthanum ions, and one or more of tellurium ions, bismuth ions, tin ions, or antimony ions can be used to form an oxide film that is substantially crack-free. This can improve performance of devices that utilize such titanium-containing oxide films as optical elements such as volume holographic gratings. Further, the example acid-stabilized precursor solutions can be used to deposit a void-free dielectric layer in a thin-film transistor. Other applications include high-density data storage, three-dimensional (3D) displays for AR and MR, advanced optical components, enhanced security and anti-counterfeiting features, and improved medical imaging.

It will be understood that the configurations and methods described herein are provided by way of example, and that these examples are not to be considered in a limiting sense because numerous variations, extensions, and omissions are also envisaged. Any of the various acts of an above method may be performed in the sequence illustrated, in other sequences, in parallel, or omitted. The subject matter of the present disclosure includes all novel and non-obvious combinations and sub-combinations of the various configurations, methods, properties, and other features disclosed herein, as well as any and all equivalents thereof.

1. A method for forming a titanium-containing oxide film by liquid-phase deposition, the method comprising:
coating a substrate with an acid-stabilized aqueous precursor solution to form a film, the acid-stabilized aqueous precursor solution comprising
titanium ions,
one or more other metal ions,
a photolyzable and/or pyrolyzable ligand, and
an acid; and
exposing the film to one or more of heat, vacuum, or light.

2. The method of claim 1, wherein the acid-stabilized precursor solution comprises titanium chloride, lanthanum chloride, and one or more of tellurium chloride, bismuth chloride, tin chloride, or antimony chloride.

3. The method of claim 1, wherein the acid comprises one or more of hydrochloric acid, nitric acid, or sulfuric acid.

4. The method of claim 1, wherein the photolyzable and/or pyrolyzable ligand comprises one or more of hydrogen peroxide, formic acid, or nitrate ion.

5. The method of claim 1, wherein exposing the film to light comprises UV curing the film.

6. The method of claim 5, further comprising annealing the film at a temperature of 60 to 650° C. after UV curing the film.

7. The method of claim 1, wherein exposing the film to heat comprises thermally curing the film at a temperature of 60 to 650° C.

8. The method of claim 1, wherein the acid-stabilized aqueous precursor solution further comprises one or more diols.

9. The method of claim 8, wherein the substrate and film form an optical element comprising a waveguide.

10. The method of claim 9, further comprising imprinting a pattern into the film before exposing the film to one or more of heat or light.

11. The method of claim 10, wherein forming the titanium-containing oxide film comprises forming a passivation layer in a thin-film transistor.

12. An acid-stabilized aqueous precursor solution for forming a titanium-containing oxide film by liquid-phase deposition, the acid-stabilized precursor solution comprising:
titanium ions;
one or more other metal ions;
a photolyzable and/or pyrolyzable ligand; and
an acid.

13. The acid-stabilized aqueous precursor solution of claim 12, wherein the one or more other metal ions comprises one or more of tellurium ions, bismuth ions, tin ions, aluminum ions, or antimony ions.

14. The acid-stabilized aqueous precursor solution of claim 13, wherein the acid comprises hydrochloric acid and the photolyzable and/or pyrolyzable ligand comprises hydrogen peroxide.

15. The acid-stabilized aqueous precursor solution of claim 12, wherein the acid comprises one or more of hydrochloric acid, nitric acid or sulfuric acid.

16. The acid-stabilized aqueous precursor solution of claim 12, wherein the photolyzable and/or pyrolyzable ligand comprises one or more of hydrogen peroxide, formic acid, or nitrate ion.

17. The acid-stabilized aqueous precursor solution of claim 12, further comprising TiO₂ nanoparticles.

18. A method of forming a metal oxide film, the method comprising:
coating a substrate with an acid-stabilized precursor solution to form a film, the acid-stabilized precursor solution comprising
metal ions,
a photolyzable and/or pyrolyzable ligand, and
an acid;
UV-curing first regions of the film and not UV-curing second regions of the film; and
heating the film.

19. The method of claim 18, wherein the method forms a diffractive grating.

20. The method of claim 18, wherein, after heating the film, the first regions of the film comprise a refractive index that is at least 0.04 greater than a refractive index of the second regions.
